(19) United States
(12) Patent Application Publication
(10) Pub. No.: US 2005/0266384 A1
(43) Pub. Date: Dec. 1, 2005

(54) Nutritional guide kit

(76) Inventors: Victoria A. Rosenberg, Monroe Township, NJ (US); Jerry M. Rosenberg, Monroe Township, NJ (US)

Correspondence Address: Richard C. Litman;LITMAN LAW OFFICES, LTD., P.O. Box 15035, Arlington, VA, 22215, US

(21) Appl. No.: 10/975,542

(22) Filed: Oct. 29, 2004

Related U.S. Application Data
(60) Provisional application No. 60/530,245, filed on Dec. 18, 2003.

(51) Int. Cl. G09B 19/00

(52) U.S. Cl. 434/127

(57) ABSTRACT

The nutritional guide kit includes a set of nutritional guide cards, a large ring, and an athletic support device. The nutritional guide cards are preferably round cards which are made of plastic or laminated so that they may endure inclement whether conditions if left outside. The cards have indicia relating to daily dietary plans and instructions imprinted thereon. Specifically, the indicia on each card provides suggestions on what types of foods to eat for each meal and when to eat each meal depending on what time of day an athletic activity is scheduled. Each nutritional guide card has an aperture defined therethrough. The ring is inserted through the aperture on each card to bind the cards together. The ring is attached to an athletic support device so that a young athlete can conveniently access the cards throughout the day.

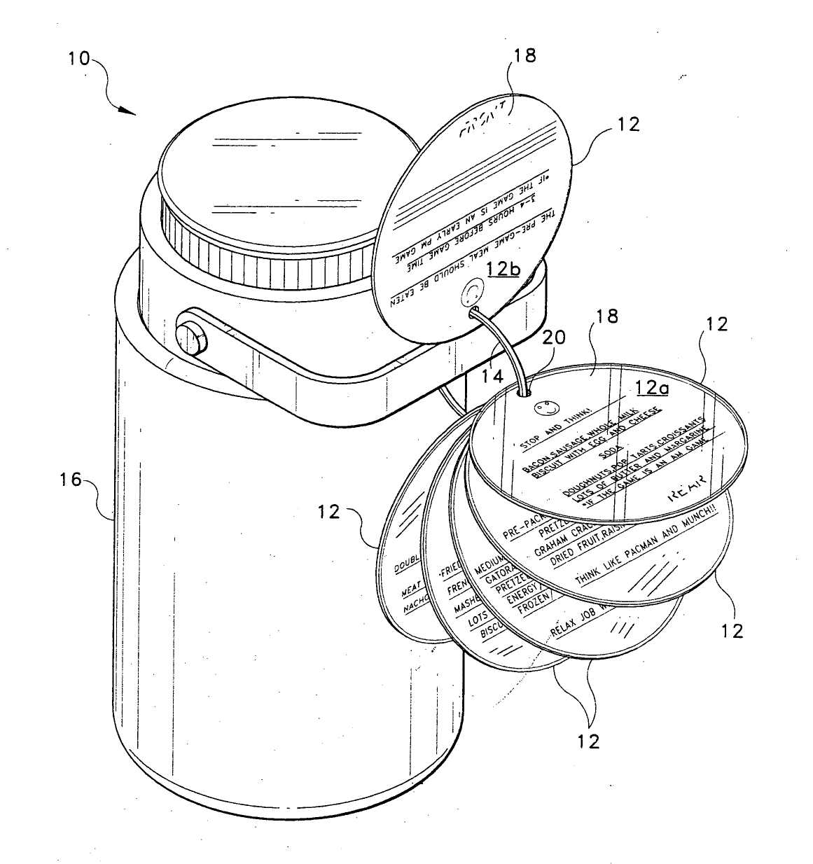

### CROSS-REFERENCE TO RELATED APPLICATION

This application claims the benefit of U.S. Provisional Patent Application Ser. No. 60/530,245, filed Dec. 18, 2003.

### BACKGROUND OF THE INVENTION

1. Field of the Invention

The present invention relates to a method and a kit for teaching children about nutrition, and more particularly, to a method and a kit which provides young athletes with instructions on how and what to eat in order to enhance performance for athletic activities.

2. Description of the Related Art

It is well known that all the elements of a balanced diet should be consumed, not at one time, but instead over the course of several meals throughout the day. However, many are uninformed as to how to incorporate the necessary dietary elements into their daily meals and how often to consume such meals throughout the day in order to efficiently meet the energy demands of their particular lifestyle. This is particularly true for young athletes who may have difficulty with carrying out the detailed advance planning required to set out a diet that will meet an assigned dietary goal for enhancing athletic performance. Given their active lifestyles, it is also cumbersome and impractical for such individuals to constantly carry with them books and magazines on dietary planning for referral throughout the day. As such, young athletes need a guide that can be quickly and easily referenced throughout the day for determining when and what to eat to enhance their athletic performance.

Aids for dietary planning have been proposed, however, none provide a nutritional guide kit for young athletes which is compact and which may be quickly accessed and referred to by an athlete throughout the day for obtaining nutritional tips.

U.S. Pat. No. 2,337,594, issued Dec. 28, 1943 to A. Easley, discloses a card system having individual cards which contain indicia of different food items. The cards are distinctively marked according to the set of cards from which they are obtained. By selecting and stacking a single card from each set, a complete well balanced diet for a meal is exposed.

U.S. Pat. No. 4,828,498, issued May 9, 1989 to C. Tilney, discloses a method and kit of components for implementing a diet using color coded food exchange cards to match foods of the major food groups in a food exchange list. Self-adhesive labels printed with various meal designations are provided for affixing to the food exchange cards. Each card represents one food exchange. Food group identifying means are also preferably provided for affixation to selected foods or food packaging.

U.S. Pat. No. 4,950,164, issued Aug. 21, 1990 to Lennon-Thompson et al., discloses a diet planning and control system and method providing a plurality of sets of cards, the cards of each set having a common code, preferably a color code. Each set contains a plurality of cards for each meal. By selecting a given color coded set, the dieter will be provided with information for complete meals on that day which satisfy the dieter's nutritional goals.

Other related patents include U.S. Pat. No. 5,683,251, issued Nov. 4, 1997 to Logan et al. (system and method for tracking dietary consumption); U.S. Pat. Nos. 4,979,901 and 5,044,958, issued Dec. 25, 1990 and September 1991, respectively, to Robertson et al. (method and apparatus for planning and controlling diet); U.S. Pat. No. 4,976,622, issued Dec. 11, 1990 to Rita M. Clark (diabetic diet plan aid and method); U.S. Pat. No. 4,689,019, issued Aug. 25, 1987 to C. Tilney (food exchanges kit and methods of constructing and utilizing same); and U.S. Pat. No. 4,310,316, issued Jan. 12, 1982 to P. L. Thomann (diet control apparatus).

None of the above inventions and patents, taken either singly or in combination, is seen to describe the instant invention as claimed. Thus, a nutritional guide kit solving the aforementioned problems is desired.

### SUMMARY OF THE INVENTION

The nutritional guide kit of the present invention includes a set of nutritional guide cards, a large ring, and an athletic support device. The nutritional guide cards are preferably round cards which are made of plastic or laminated so that they may endure inclement whether conditions if left outside. The cards have indicia relating to daily dietary plans and instructions imprinted thereon. Specifically, the indicia on each card provides suggestions on what types of foods to eat for each meal and when to eat each meal depending on what time of day an athletic activity is scheduled. Each nutritional guide card has an aperture defined therethrough. The ring is inserted through the aperture on each card to bind the cards together. The ring is attached to an athletic support device so that a young athlete can conveniently access the cards throughout the day.

Accordingly, it is a principal object of the invention to teach a young athlete how to maintain a balanced diet and enhance athletic performance by providing a nutritional guide kit which can be easily accessed for quick referral.

It is another object of the invention to provide a nutritional guide kit for instructing young athletes how to enhance athletic performance by eating certain foods and by eating at particular times of the day.

It is a further object of the invention to provide a nutritional guide kit which may be kept outdoors even during inclement whether conditions.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

The sole FIGURE is an environmental, perspective view of a nutritional guide kit according to the present invention.

### DETAILED DESCRIPTION OF THE PREFERRED EMBODIMENT

The present invention relates to a nutritional guide kit, generally designated as 10 in the drawings. The nutritional guide kit 10 includes a set of nutritional guide cards 12, a large ring 14, and an athletic support device 16.

The nutritional guide cards 12 can be made from any suitable material that is durable and weatherproof. Preferably, the nutritional guide cards 12 are made from a heavy paper or cardboard material that is laminated for protection, or made from a suitable plastic or other weatherproof material. The nutritional guide cards 12 have indicia 18 printed thereon providing instructions on when and what to eat before and after an athletic activity. The indicia 18 are printed on both a front side 12a and a rear side 12b of the cards 12. For example, a front side 12a of the card 12 may provide instructions on what to eat for breakfast if the game is an early afternoon game and may include motivational indicia such as “GO FOR IT!” imprinted thereon. The rear side 12b of the card may include precautionary indicia such as “STOP AND THINK” along with a list of items which are not recommended for an athlete to eat for breakfast.

Each nutritional guide card 12 has an aperture 20 defined therethrough. The ring 14 is inserted through the aperture 20 of each card 12 to bind the cards together. The ring 14 is attached to the athletic support device 16 so that a young athlete can conveniently access the cards 12 whenever necessary. An athletic support device 16 includes any device commonly carried by an athlete to store food, drinks, or athletic goods. An athletic support device can include, for example, an icebox, a thermos, a drink bottle, or a sports bag.

Although the nutritional guide cards 12 and the large ring 14 binding the cards 12 together may be used by themselves, the nutritional guide cards 12 are advantageously attached to the athletic support device 16 by the ring 14 so that when the student athlete reaches for a drink, a food item, or athletic wear or equipment, the student athlete's attention is immediately directed to the nutritional guide cards 12 attached to the handle of the support device 16, where he or she receives advice and instruction on proper nutrition. It will be understood that although the nutritional guide cards 12 are preferably bound together by a large metal ring 14, the cards 12 may alternatively be bound together by a strap, link, chain, band, or other device which can bind the cards together and be used to tether the cards to an athletic support device 16.

It is to be understood that the present invention is not limited to the embodiment described above, but encompasses any and all embodiments within the scope of the following claims.

1. A nutritional guide kit, comprising:
a plurality of nutritional guide cards having an aperture defined therethrough, and having indicia printed thereon providing instructions on when and what to eat before and after an athletic activity; and
a ring inserted through the aperture of each of the guide cards.

2. The nutritional guide kit of claim 1 further comprising an athletic support device, said ring being attached to the support device.

3. The nutritional guide kit of claim 1, wherein said nutritional guide cards are laminated.

4. The nutritional guide kit of claim 1, wherein said nutritional guide cards are made of plastic.

5. A nutritional guide kit, comprising:
a plurality of nutritional guide cards having an aperture defined therethrough, and having indicia printed thereon providing instructions on when and what to eat before and after an athletic activity;
an athletic support device; and
means for attaching said cards to said athletic support device.

6. A method for instructing a young athlete on how to maintain a balanced diet and enhance athletic performance, comprising the steps of:
(a) providing a set of nutritional guide cards having indicia printed thereon relating to when and what to eat before and after an athletic activity;
(b) providing an aperture through said set of nutritional guide cards;
(c) inserting a binding device through the aperture of each said nutritional guide card for binding together said set of nutritional guide cards; and
(d) tethering said binding device to an athletic support device.
